(19) United States
(12) Patent Application Publication
(10) Pub. No.: US 2024/0222650 A1
(43) Pub. Date: Jul. 4, 2024

(54) ZN BATTERY ELECTRODE MATERIAL AND METHOD OF PRODUCING THE SAME

(71) Applicant: Research & Business Foundation SUNGKYUNKWAN UNIVERSITY, Suwon-si (KR)

(72) Inventors: Ho Seok PARK, Seongnam-si (KR); Gun JANG, Suwon-si (KR); Hongdae LEE, Suwon-si (KR)

(73) Assignee: Research & Business Foundation SUNGKYUNKWAN UNIVERSITY, Suwon-si (KR)

(21) Appl. No.: 18/610,484

(22) Filed: Mar. 20, 2024

Related U.S. Application Data
(63) Continuation-in-part of application No. 18/379,894, filed on Oct. 13, 2023.

(30) Foreign Application Priority Data
Oct. 13, 2022 (KR) 10-2022-0131837
Mar. 20, 2023 (KR) 10-2023-0035925

(51) Int. Cl. H01M 4/90; C01G 49/00; H01M 4/02; H01M 4/36; H01M 4/525; H01M 4/587; H01M 4/86; H01M 10/054; H01M 12/08

(52) U.S. Cl. CPC H01M 4/9041; C01G 49/0018; H01M 4/366; H01M 4/525; H01M 4/587; H01M 10/054; H01M 12/08; C01P 2002/32; C01P 2004/12; C01P 2004/80; C01P 2006/40; H01M 2004/028; H01M 2004/8689

(57) ABSTRACT

Disclosed are a metal carbide catalyst composite for abifunctional zinc-air battery, which contains both vanadium metal and heterogeneous transition metal, and a zinc-air battery system containing the same. According to an embodiment of the disclosure, a catalyst reaction area is increased by substituted iron and vanadium ions of the metal carbide catalyst composite for the zinc-air battery, thereby exhibiting high activity for ORR performance as well as OER performance.

Additionally, an embodiment of the present invention provides a material for a positive electrode active material for secondary batteries and a method for manufacturing a material for a positive active material for secondary batteries. In detail, it provides a material for secondary battery positive electrode active material and a method of manufacturing a material for secondary battery positive electrode active material that can utilize a carbon-coated iron-vanadium metal oxide structure as a secondary battery positive active material.

### CROSS REFERENCE TO RELATED APPLICATION

The present application claims priority to Korean Patent Application No. 10-2022-0131837, filed on Oct. 13, 2022, and Korean Patent Application No. 10-2023-0035925, filed on Mar. 20, 2023, the entire contents of which is incorporated herein for all purposes by this reference.

### BACKGROUND OF THE INVENTION

### Field of the Invention

The disclosure relates to a metal carbide catalyst composite for a bifunctional zinc-air battery, which contains both vanadium metal and heterogeneous transition metal, and a zinc-air battery system containing the same. Further, the disclosure involves a material for a secondary battery positive electrode active material and a method of producing the same, and more particularly relates to a material for a secondary battery positive electrode active material, which uses a carbon-coated iron-vanadium metal oxide structure as the secondary battery positive electrode active material, and a method of producing the same.

### Description of the Related Art

With ever-increasing concerns about energy crisis and environmental pollution, research and development on technologies for storing and converting renewable energy have attracted attention.

Among such technologies, a zinc-air battery is in the limelight as a promising energy storage device because the zinc-air battery has high energy density and eco-friendly.

In this case, the discharge of the zinc-air battery refers to a process in which oxygen in air dissolves in an electrolyte through an air electrode (or positive electrode) and reacts with water to form a hydroxyl ion. This reaction is reversible. The process of reducing oxygen is a discharging process, and the process of oxidizing the hydroxyl ion as a reverse reaction is a charging process.

The reaction of reducing oxygen in the discharging process is called an oxygen reduction reaction (ORR), and the reaction of oxidizing the hydroxyl ion in the charging process is called an oxygen evolution reaction (OER).

In this case, to enable both the charge and discharge of the zinc-air battery, both reactions, i.e., the ORR and the OER should be possible in the air electrode (or positive electrode).

A conventional zinc-air battery has a theoretical open circuit voltage (OCV) of 1.667V in a basic electrolyte.

However, in reality, a lower discharging voltage is output due to a slow ORR, and a higher charging voltage is required due to a slow OER.

Accordingly, an electrocatalyst for enabling a faster ORR and a faster OER by lowering overpotential is required. Catalysts based on platinum (Pt) and palladium (Pd) have been mainly used as conventional ORR catalysts, and catalysts based on iridium oxide (IrOz) and ruthenium oxide (RuOz) have been mainly used as conventional OER catalysts. Such conventional catalysts have several problems.

First, the foregoing catalysts are very difficult to commercialize because they are based on precious metals, which are very expensive, have limited reserves and are sensitive to change in supply.

Further, the foregoing catalysts have no activity to each other.

In other words, the ORR catalysts such as platinum (Pt) or palladium (Pd) have no OER activity, and the OER catalysts such as iridium oxide (IrO₂) or ruthenium oxide (RuO₂) have no ORR activity, and therefore their use in the positive electrode of the zinc-air battery is limited.

Accordingly, to replace the expensive precious metals and improve the performance of the zinc-air battery, there is a need to develop a bifunctional oxygen catalyst that enables both the ORR and the OER and has high activity.

Besides, the application fields of a conventional metal organic framework (MOF) have been limited to carbon capture technology based on a porous structure, a sensor, etc. In the case of an energy storage field, the use of the MOF has been conductivity. However, the extremely limited due to low conductivity of the MOF has been largely increased by carbonizing organic materials through a reforming method based on high-temperature heat treatment, and thus energy storage materials using various MOFs are being actively studied.

However, carbon composite metal oxide obtained from the MOF is synthesized using a single metal element, and it is thus difficult to provide an alternative that overcomes the shortcomings of the corresponding transition metal when carbon composite metal oxide is used as the energy storage material, in particular, the material for the secondary battery positive electrode active material.

Accordingly, to solve the aforementioned problems, the present inventor has completed a material for a secondary battery positive electrode active material, which can be used as the energy storage material through a carbon-coated iron-vanadium metal oxide framework synthesis based on a vanadium organic frame, and a method of producing the same.

### Documents of Related Art

(Patent Document 1) Korean Patent Publication No. 2017-0039727
(Patent Document 2) Chinese Patent Publication No.

### SUMMARY OF THE INVENTION

An aspect of the disclosure is to provide a metal organic frame (MOF)-derived catalyst composite for a bifunctional zinc-air battery, which contains both vanadium metal and heterogeneous transition metal, and a zinc-air battery system containing the same.

Another aspect of the disclosure is to provide a material for a secondary battery positive electrode active material, which contains a carbon-coated iron-vanadium metal oxide structure.

Still another aspect of the disclosure is to provide a method of producing a material for a secondary battery positive electrode active material, including: a vanadium organic framework solution preparation step of preparing a vanadium organic framework by reacting a vanadium salt and a compound containing two or more carboxyl groups in a solvent; an iron-vanadium organic framework solution preparation step of preparing an iron-vanadium organic framework solution to prepare an iron-vanadium organic framework by substituting some of vanadium in the vanadium organic framework with iron in such a way that a compound containing iron is added to the vanadium organic framework solution and heated; and a carbon-coated iron-vanadium metal oxide framework preparation step of preparing a carbon-coated iron-vanadium metal oxide framework by heating the iron-vanadium organic framework solution.

Technical problems to be solved in the disclosure are not limited to the forementioned technical problems, and other unmentioned technical problems can be clearly understood from the following description by a person having ordinary knowledge in the art to which the disclosure pertains.

To solve the technical problems, there is provided a metal carbide t composite for a zinc-air battery according to an embodiment of the disclosure.

According to an embodiment of the disclosure, the metal carbide catalyst composite for the zinc-air battery may be a porous carbide compound that contains vanadium metal and heterogeneous transition metal.

Further, according to an embodiment of the disclosure, the heterogeneous transition metal may contain one selected from a group consisting of Fe, Ni or Co.

Further, according to an embodiment of the disclosure, the content of the vanadium metal may range from 50 wt % to 83 wt %.

Further, according to an embodiment of the disclosure, the content of the heterogeneous transition metal may range from 10 wt % to 20 wt %.

Further, according to an embodiment of the disclosure, a particle diameter may range from 200 nm to 500 nm.

To solve the technical problems, there is provided a method of producing a metal carbide catalyst composite for a embodiment of the zinc-air battery according to another disclosure.

According to an embodiment of the disclosure, the method of producing the metal carbide catalyst composite for the zinc-air battery may include preparing a metal organic framework that contains vanadium metal (V-MOF);
forming a MOF catalyst composite precursor by substituting some of vanadium metal of the V-MOF with heterogeneous transition metal; and
preparing the metal carbide catalyst composite that contains both vanadium metal and heterogeneous transition metal by subjecting the MOF catalyst composite precursor to heat treatment.

Further, according to an embodiment of the disclosure, in the preparation of the V-MOF, the metal organic framework (MOF) may include one selected from a metal organic composite group consisting of MIL-47 series, vanadium metal nodes, and organic ligands.

Further, according to an embodiment of the disclosure, in the formation of the MOF catalyst composite precursor, the heterogeneous transition metal may contain Fe, Ni or Co.

Further, according to an embodiment of the disclosure, in the preparation of the metal carbide catalyst composite, the heat treatment is performed within a temperature range from 800° ° C. to 1000° C.

Further, according to an embodiment of the disclosure, the content of the vanadium metal may range from 50 wt % to 83 wt %.

Further, according to an embodiment of the disclosure, the content of the heterogeneous transition metal may range from 10 wt % to 20 wt %.

To solve the technical problems, there is provided a zinc-air battery system according to another embodiment of the disclosure.

According to an embodiment of the disclosure, the zinc-air battery system includes a positive electrode that contains the foregoing metal carbide catalyst composite for the zinc-air battery to react with oxygen in air; a negative electrode disposed to face the positive electrode and containing zinc; and an electrolyte solution.

Further, according to an embodiment of the disclosure, the electrolyte solution may include an acidic aqueous solution or an alkaline aqueous solution.

To solve the technical problems, there is provided a material for a secondary battery positive electrode active material, which includes a carbon-coated iron-vanadium metal oxide framework according to another embodiment of the disclosure.

According to an embodiment of the disclosure, the secondary battery includes a multivalent ion secondary battery.

According to an embodiment of the disclosure, the multivalent ion secondary battery may include a zinc ion secondary battery or a magnesium ion secondary battery.

According to an embodiment of the disclosure, the iron-vanadium metal oxide structure is represented by the following Chemical Formula 1.

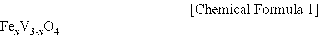

(where, x is 1 to 2)

According to an embodiment of the disclosure, the iron-vanadium metal oxide framework may have a spinel structure.

According to an embodiment of the disclosure, the iron-vanadium metal oxide has a tubular morphology.

According to an embodiment of the disclosure, the iron-vanadium metal oxide hierarchically coated with a turbostratic carbon layers has a porous nanotubular structure, where the smaller nanocrystalline iron-vanadium metal oxide spinel phase was embedded into the amorphous V—O—Fe phase.

According to an embodiment of the disclosure, the iron act as a pillar to stabilize the reconstructed crystal structure through the chemical bond with oxygen when the crystal lattice is expanded upon the multivalent ion insertion.

To solve the technical problems, there is provided a secondary battery including: a secondary battery positive electrode that contains the foregoing material for a secondary battery positive electrode active material; a negative electrode; and an electrolyte.

To solve the technical problems, according to another embodiment of the disclosure, there is provided a method of producing a material for a secondary battery positive electrode active material, including: a vanadium organic framework solution preparation step of preparing a vanadium organic framework by reacting a vanadium salt and a compound containing two or more carboxyl groups in a solvent; an iron-vanadium organic framework solution preparation step of preparing an iron-vanadium organic framework solution to prepare an iron-vanadium organic framework by substituting some of vanadium in the vanadium organic framework with iron in such a way that a compound containing added to the vanadium organic framework solution and heated; and a carbon-coated iron-vanadium metal oxide framework preparation step of preparing a carbon-coated iron-vanadium metal oxide framework by heating the iron-vanadium organic framework solution.

According to an embodiment of the disclosure, the vanadium salt may be selected from a group consisting of vanadium trichloride and vanadium salts with three valence electrons.

According to an embodiment of the disclosure, the carboxyl group of the compound containing two or more carboxyl groups may be selected from a group consisting of naphthalene dicarboxylate and benzenedicarboxylate.

According to an embodiment of the disclosure, the solvent may include water.

According to an embodiment of the disclosure, when the compound containing iron is added to the vanadium organic framework solution, the pH value of the solution may be lowered.

According to an embodiment of the disclosure, the compound containing iron may be selected from a group consisting of iron trichloride and iron salts with three valence electrodes.

According to an embodiment of the disclosure, in the iron-vanadium organic framework solution preparation step, a heating condition may include heating at a temperature of 50 to 120° C. for 9 to 16 hours.

According to an embodiment of the disclosure, in the carbon-coated iron-vanadium metal oxide framework preparation step, a heating condition may include heating at a temperature of 500 to 1000° C. for 2 to 6 hours.

According to an embodiment of the disclosure, the solvent may include water.

### BRIEF DESCRIPTION OF THE DRAWINGS

FIG. 1 is a transmission electron microscope (TEM) image showing a structure of a metal carbide catalyst composite for a zinc-air battery according to an embodiment of the disclosure.

FIG. 2 is a schematic diagram showing a method of preparing a metal carbide catalyst composite for a zinc-air battery according to an embodiment of the disclosure.

FIG. 3 is a scanning electron microscope (SEM) image of Preparation Example 1.

FIG. 4 shows X-ray diffraction (XRD) analysis results of Preparation Example 1.

FIG. 5 is a graph showing a charging and discharging polarization curve and a power density curve of Preparation Example 2.

FIG. 6 shows stability test results of constant current charging and discharging cycle of Preparation Example 2.

FIG. 7 is a diagram showing a method of producing a material for a secondary battery positive electrode active material according to an embodiment of the disclosure.

FIG. 8 shows SEM and TEM images of a tube-shaped material for a secondary battery positive electrode active material according to an embodiment of the disclosure.

FIG. 9 is a diagram showing the structure of an iron-vanadium metal oxide structure according to an embodiment of the disclosure.

FIG. 10 shows the structures of an iron-vanadium metal oxide structure (FeV₂O₄) and a carbon-coated iron-vanadium metal oxide structure according to an embodiment of the disclosure, in which (a) shows a TEM image of a carbon coating layer of FeV₂O₄ and its internal crystal, and (b) shows nanocrystals of FeV₂O₄ coated with carbon.

FIG. 11 is a diagram showing a crystal structure of nanocrystals of a carbon-coated iron-vanadium metal oxide structure according to an embodiment of the disclosure.

FIG. 12 is a TEM image of composition forming the inside of a structure according to an embodiment of the disclosure.

FIG. 13 shows results of applying a material for a secondary battery positive electrode active material according to an embodiment of the disclosure as a positive electrode material to a zinc ion battery.

FIG. 14 shows results of applying a material for a secondary battery positive electrode active material an embodiment of the disclosure as a positive electrode material to a magnesium ion battery.

FIG. 15 shows comparison in capacity performance of a secondary battery between vanadium oxide and vanadium-iron oxide according to an embodiment of the disclosure.

FIG. 16 shows difference in charging and discharging voltages of a secondary battery between vanadium oxide and vanadium-iron oxide according to an embodiment of the disclosure.

FIG. 17 shows difference in energy density of a secondary battery between vanadium oxide and vanadium-iron oxide according to an embodiment of the disclosure.

### DETAILED DESCRIPTION OF THE INVENTION

Hereinafter, the disclosure will be described with reference to the accompanying drawings. However, the disclosure may be implemented in various different forms, and is not limited to the embodiments described herein. In the drawings, parts unrelated to the description are omitted to clearly describe the disclosure, and like numerals refer to like components throughout the specification.

Throughout the specification, when a part is referred to as being “connected (accessed, contacted, coupled)” to another part, not only it can be “directly connected” to the other part but it can also be “indirectly connected” to the other part via an intervening member. Further, when a certain part is referred to as “including” a certain component, this indicates that other components are not excluded but may be additionally included uncles otherwise noted.

The terms used in this specification are only used to describe specific embodiments, but not intended to limit the disclosure. Unless the context clearly dictates otherwise, singular forms include plural forms as well. In this specification, “it should be understood that term “include” or “have” indicates that a feature, a number, a step, an operation, a component, a part, or the combination thereof described in the embodiments is present, but does not preclude a possibility of presence or addition of one or more other features, numbers, steps, operations, components, parts or combinations thereof, in advance.

Below, the embodiments of the disclosure will be described in detail with reference to the accompanying drawings.

A metal carbide catalyst composite for a zinc-air battery according to an embodiment of the disclosure is as follows.

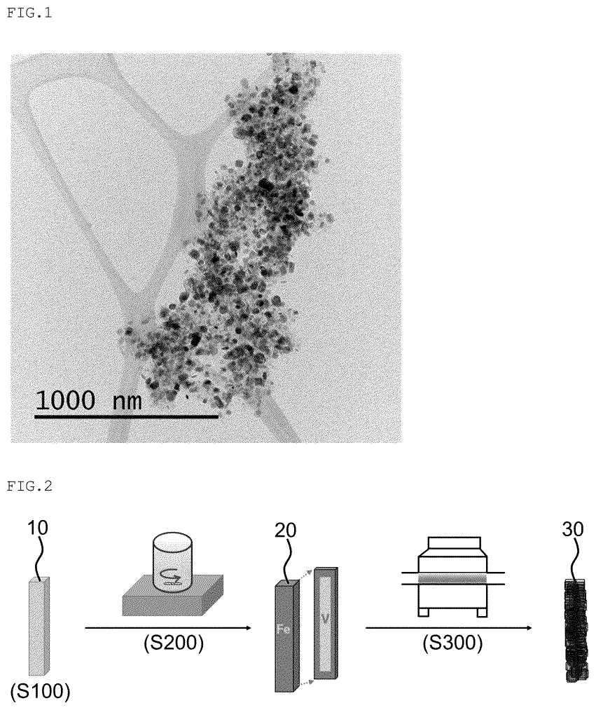

FIG. 1 is a transmission electron microscope (TEM) image showing a structure of a metal carbide catalyst composite for the zinc-air battery according to an embodiment of the disclosure.

The metal carbide catalyst composite for the zinc-air battery according to an embodiment of the disclosure may be a porous carbide compound that contains vanadium metal and heterogeneous transition metal.

Referring to FIG. 1, it will be appreciated that a carbon framework contains vanadium metal and heterogeneous transition metal.

Specifically, the metal carbide catalyst composite (Fe/V—C) may be a porous carbide compound substituted with heterogeneous transition metal.

In this case, “/” in “Fe/V—C” may mean that Fe and V are present in parallel and located as a mixed structure in a carbon framework.

The metal carbide catalyst composite for the zinc-air battery is porous vanadium carbide substituted with heterogeneous transition metal, which may be a porous carbide compound prepared by substituting some of vanadium metal with the heterogeneous transition metal in the vanadium metal 5 organic framework (MOF) and then being subjected to heat treatment.

First, the metal carbide catalyst composite for the zinc-air battery according to an embodiment of the disclosure may have porous characteristics.

In metal carbide compound catalyst composite according to an embodiment of the disclosure, the MOF is subjected to the heat treatment to prepare a carbide compound. The metal carbide catalyst composite according to the disclosure may have a pore size of 27 nm to 104 nm.

Due to the porous surface of the metal carbide catalyst composite, the zinc-air battery containing the metal carbide catalyst composite may be improved in oxygen reduction reaction (ORR) evolution reaction (OER) performance and oxygen performance.

Further, vanadium metal may be contained according to the disclosure.

In this case, the vanadium metal may be located in the carbon framework of carbide and chemically bonded to carbon, and a carbide compound containing the vanadium metal has porous and conductive characteristics and may be effective as a supports.

Further, according to the disclosure, vanadium metal is further contained in addition to one type of transition metal contained in the existing electrocatalyst, thereby preparing an electrocatalyst having bimetal properties.

In this case, metal carbide having the bimetal properties has more reaction sites than the existing catalyst containing one type of transition metal, thereby improving the performance of the catalyst.

In this case, according to the disclosure, the content of the vanadium metal may range from 50 wt % to 83 wt %.

The reason why the content of the vanadium metal ranges from 50 wt % to 83 wt % is because a problem arises in forming a crystal structure in the case of being less than 50 wt %, and there is a problem that the vanadium metal is formed in the case of being more than 83 wt %.

Further, heterogeneous transition metal may be contained according to the disclosure.

The heterogeneous transition metal may contain one selected from a group consisting of Fe, Ni or Co.

The reason why Fe, Ni or Co is selected as the heterogeneous transition metal is because the conductive properties of Fe, Ni or Co are suitable for an electrochemical catalyst.

In this case, the heterogeneous transition metal is located where it is mixed with vanadium carbide, and thus physically bonded to extra carbon, and a carbide compound containing the heterogeneous transition metal has porous and conductive characteristics so that the zinc-air battery can be improved in the ORR performance and the OER performance, thereby having an effect on improving the charging and discharging performance of the zinc-air battery.

Further, each of the heterogeneous transition metal and the vanadium metal is located inside a carbon framework (carbide) and present in a dispersed form as being surrounded with carbon materials, thereby having effects on enhancing electrical conductivity and increasing a catalytic reaction area.

In this case, the content of the heterogeneous transition metal may range from 10 wt % to 20 wt %.

In this case, a problem of lowering the catalyst performance may arise when the content of the heterogeneous transition metal is less than 10 wt %, and a problem may arise in forming carbide when the content is more than 20 wt %.

In this case, the metal carbide catalyst composite for the zinc-air battery may have a particle diameter of 200 nm to 500 nm.

In this case, there may be a problem of particle size nonuniformity when the particle diameter of the metal carbide catalyst composite for the zinc-air battery is less than 200 nm or less, and there may be a problem of lowering the catalyst performance when the particle diameter is more than 500 nm.

In this case, the particle size of the metal carbide catalyst composite for the zinc-air battery may be adjusted based on the concentration of a reaction solution, reaction time, and a heat treatment temperature.

The concentration of the reaction solution, the reaction time, and the heat treatment temperature for adjusting the particle size will be described in detail while describing a method of preparing the metal carbide catalyst composite for the zinc-air battery.

The heterogeneous transition metal is present in a single phase separated from a carbide phase within the carbon framework, and may be single metal or metal oxide.

The method of preparing the metal carbide catalyst composite for the zinc-air battery according to another embodiment of the disclosure will be described.

FIG. 2 is a schematic diagram showing a method of preparing a metal carbide catalyst composite for a zinc-air battery according to an embodiment of the disclosure.

In FIG. 2, the method of preparing a metal carbide catalyst composite for a zinc-air battery according to an embodiment of the disclosure may include the steps of:

preparing a metal organic framework containing vanadium metal (V-MOF) 10 (S100); (forming a MOF catalyst composite precursor 20 by substituting some of vanadium metal in the metal organic framework containing vanadium metal (V-MOF) with heterogeneous transition metal (S200); and preparing a metal carbide catalyst composite 30 containing both the vanadium metal and the heterogeneous transition metal by subjecting the MOF catalyst composite precursor to heat treatment (S300).

The first step may include preparing the metal organic framework containing vanadium metal (V-MOF) 10 (S100)

The MOFs are a type of porous material product, and may include an organic linker such as metal clusters/ions. The MOFs include the metal clusters/ions or the like organic linker, and are referred to as secondary building units (SBUs). The structure of the MOF may be modified because its chemical composition is adjustable.

The MOF has a large surface area and high porosity, and is thus variously applied to catalysts, gas absorption, sensors, drug delivery, etc.

In this case, the MOF used according to the disclosure may include MIL-47, and may include any material without limitations to the foregoing example as long as it has the properties of a metal organic framework compound.

In this case, as an example of preparing the MOF containing the vanadium metal, vanadium (III) chloride and 1,4-naphthalenedicarboxylate were subjected to the heat treatment at 200° C. for 48 hours, thereby preparing a V-MOF compound (MIL-47).

In this case, the vanadium metal may be located within the MOF.

The second step may include forming the MOF catalyst composite precursor 20 by substituting some of vanadium metal in the V-MOF with heterogeneous transition metal (S200).

In this case, the heterogeneous transition metal my contain Fe, Ni or Co.

In this case, as an example of substituting some of vanadium metal in the V-MOF with heterogeneous transition metal, 500 mg of V-MOF (MIL-47) was added to a solvent of 250 mg of iron (III) chloride, and subjected to a hydrothermal reaction at 80° C. for 12 hours, thereby forming a MOF catalyst composite precursor, i.e., FeV-MOF.

In this case, a mixture solution of the iron (III) chloride and V-MOF (MIL-47) may have a concentration of 15 mg/ml to 20 mg/ml. When the concentration of the mixture solution is lower than 15 mg/ml, there may be a problem that vanadium is not substituted without reaching sufficient acidity. When the concentration of the mixture solution is higher than 20 mg/ml, there may be a problem that the MOF is decomposed because the acidity is too high.

The third step may include preparing the metal carbide catalyst composite 30 containing both the vanadium metal and the heterogeneous transition metal by subjecting the MOF catalyst composite precursor to the heat treatment (S300).

In this case, as an example of preparing a Fe/V—C compound as the catalyst composite, the FeV-MOF may be subjected to the heat treatment at 900° C. for 1 hour.

In this case, the heat treatment may be performed within a temperature range from 800° C. to 1000° C.

The reason why the heat treatment is performed within the temperature range from 800° C. to 1000° C. is because metal oxide that may be produced at a low temperature is suppressed.

When the temperature for the heat treatment is lower than 800° C., metal carbide may not be produced. On the other hand, when the temperature for the heat treatment is higher than 1000° C., vanadium may be eluted.

Further, the heat treatment may be performed for 1 to 10 hours.

When the heat treatment is performed for not more than 1 hour, metal carbide may not be produced. On the other hand, when the heat treatment is performed for not less than 10 hours, the size of nanoparticles may no longer increase, thereby causing a problem in a processing efficiency.

Thus, according to an embodiment of the disclosure, the MOF-derived catalyst composite for the zinc-air battery exhibits high activity for not only the OER performance but also the ORR performance due to its high specific surface area.

Further, a catalyst reaction area may be increased by the substituted iron and vanadium ions of the metal carbide catalyst composite for the zinc-air battery according to an embodiment of the disclosure, thereby exhibiting high activity for the ORR performance as well as the OER performance.

Further, the zinc-air battery system containing the metal carbide catalyst composite for the bifunctional zinc-air battery according to an embodiment of the disclosure is excellent in electrical conductivity, and exhibits excellent charging and discharging performance and stability due to its high specific surface area.

Further, the method of preparing the metal carbide catalyst composite for the bifunctional zinc-air battery according to an embodiment of the disclosure may employ hydrothermal synthesis, solution synthesis, and heat treatment processes, and has an effect of controlling the size of nanoparticles by adjusting the concentration of the solution, the reaction time of the heat treatment, and the temperature of the heat treatment.

The zinc-air battery system according to another embodiment of the disclosure will be described.

According to an embodiment of the disclosure, the zinc-air battery system may include a positive electrode that contains the foregoing metal carbide catalyst composite for the zinc-air battery to react with oxygen in air; a negative electrode disposed to face the positive electrode and containing zinc; and an electrolyte solution.

The zinc-air battery system refers to a kind of air battery that operates as oxygen in air reacts with zinc mixed in the electrolyte solution through an air electrode of the battery.

In the zinc-air battery system, the positive electrode may use oxygen in air, thereby theoretically decreasing the weight of the positive electrode significantly.

Therefore, the weight of the negative electrode is allowed to increase as much as the decreased weight of the positive electrode, so that a weight ratio of the negative electrode to the whole zinc-air battery system can be increased, thereby providing high energy density per unit weight of the battery.

In this case, the electrolyte solution may be located between the positive electrode and the negative electrode, and contain an electrolyte material. In this case, the electrolyte solution may for example include a sodium hydroxide (NaOH) solution or a Potassium hydroxide (KOH) solution. Further, a solid medium may be used instead of the electrolyte solution. According to the disclosure, the electrolyte solution includes an acidic aqueous solution or an alkaline aqueous solution.

Below, power generation in the zinc-air battery system will be described.

In the negative electrode and the positive electrode, a discharging reaction and a charging reaction may occur. The discharging action in the negative electrode and the positive electrode is as follows. In the charging reaction, the following reactions occur in the reverse direction. In the following reaction formulae, “M” refers to a material of an anode 110, and may include metal.

### <Reaction in Negative Electrode>

$$M - > {M}^{n +} + n {e}^{-}$$

### <Reaction in Positive Electrode>

$${O}_{2} + 2 {H}_{2} O + 4 {e}^{-} - > 4 {OH}^{-}$$

By the discharging reaction, cations generated in the negative electrode travel toward the positive electrode via the electrolyte. In this case, electrons lost from the cations pass through a load via a separate conducting wire, thereby resulting in supplying power to the load.

Oxygen is supplied from the outside to the positive electrode, and the cations react with oxygen in the positive electrode to produce an oxide. In this case, the electrons passed through the load are supplied to the positive electrode, thereby producing the oxide together.

On the other hand, during the charging reaction, the oxide is decomposed and the cations acquire the electrons and return from the positive electrode to the negative electrode via the electrolyte.

According to the disclosure, the positive electrode includes the metal carbide catalyst composite for the zinc-air battery may further enhance the efficiency of the ORR where oxygen in air is reduced during the discharging process based on the electrocatalyst reaction of the catalyst composite and the efficiency of the OER where hydroxyl ions are oxidized during the charging process.

In this case, the proof of the efficiency in the ORR and the OER will be described in detail through the following experimental examples.

According to still another embodiment of the disclosure, there is provided a material for a secondary battery positive electrode active material, which has a carbon-coated iron-vanadium metal oxide framework. Due to strong crystallinity of iron-vanadium-oxygen (Fe—V—O) in the iron-vanadium metal oxide framework of the carbon-coated iron-vanadium metal oxide framework, spaces for insertion and extraction of specific multivalent ions such as magnesium (Mg) ions and zinc (Zn) ions are provided, and energy storage performance are improved. Further, a carbon composite by which the iron-vanadium metal oxide framework is carbonized may increase the specific surface area and pores, and may increase electrolyte diffusion performance.

According to an embodiment of the disclosure, the secondary battery may be a multivalent-ion secondary battery. The carbon-coated iron-vanadium metal oxide framework is used as a material for a positive electrode active material of the multivalent-ion secondary battery, thereby providing the spaces for the insertion and extraction of specific multivalent ions such as magnesium (Mg) ions and zinc (Zn) ions.

According to an embodiment of the disclosure, the multivalent-ion secondary battery may include a zinc-ion secondary battery or a magnesium-ion secondary battery. When the multivalent-ion secondary battery is the zinc-ion secondary battery or the magnesium-ion secondary battery, the energy storage performance may be improved and the energy density may be improved.

According to an embodiment of the disclosure, the iron-vanadium metal oxide framework may be represented by the following Chemical Formula 1.

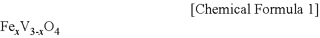

(where, x is 1 to 2)

The iron-vanadium metal oxide framework represented by the Chemical Formula 1 may have a stable crystal structure than that of vanadium metal oxide.

According to an embodiment of the disclosure, the iron-vanadium metal oxide framework may have a spinel structure. The iron-vanadium metal oxide framework having the spinel structure may improve the energy storage performance gradually between the charging and discharging of the battery.

According to an embodiment of the disclosure, the iron-vanadium metal oxide has a tubular morphology.

According to an embodiment of the disclosure, the iron-vanadium metal oxide hierarchically coated with a turbostratic carbon layers has a porous nanotubular structure, where the smaller nanocrystalline iron-vanadium metal oxide spinel phase was embedded into the amorphous V—O—Fe phase.

According to an embodiment of the disclosure, the iron act as a pillar to stabilize the reconstructed crystal structure through the chemical bond with oxygen when the crystal lattice is expanded upon the multivalent ion insertion.

To solve the technical problems, another embodiment of the disclosure provides a secondary battery including a secondary battery positive electrode, which contains the foregoing material for the secondary battery positive electrode active material, a negative electrode, and an electrolyte.

To solve the technical problems, another embodiment of the disclosure provides a method of producing a material for a secondary battery positive electrode active material, the method including: a vanadium organic framework solution preparation step of preparing a vanadium organic framework by reacting a vanadium salt and a compound containing two or more carboxyl groups in a solvent; an iron-vanadium organic framework solution preparation step of preparing an iron-vanadium organic framework solution to prepare an iron-vanadium organic framework by substituting some of vanadium in the vanadium organic framework with iron in such a way that a compound containing iron is added to the vanadium organic framework solution and heated; and a carbon-coated iron-vanadium metal oxide framework preparation step of preparing a carbon-coated iron-vanadium metal oxide framework by heating the iron-vanadium organic framework solution.

FIG. 7 is a diagram showing a method of producing a material for a secondary battery positive electrode active material according to an embodiment of the disclosure.

Referring to FIG. 7, the metal oxide frameworks of iron and vanadium may be represented by the following Chemical Formula 1.

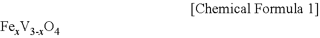

(where, x is 1 to 2)

The carboxyl group of the compound containing two or more carboxyl groups may be chemically bonded to vanadium of the vanadium salt, preferably by a coordination bond.

According to an embodiment of the disclosure, the vanadium salt may be selected from a group consisting of vanadium trichloride and vanadium salts with three valence electrons.

According to an embodiment of the disclosure, the carboxyl group of the compound containing two or more carboxyl groups may be selected from a group consisting of naphthalene dicarboxylate and benzenedicarboxylate.

According to an embodiment of the disclosure, the solvent may include water. The solvent may include water, and may not include an organic solvent.

According to an embodiment of the disclosure, when the compound containing iron is added to the vanadium organic framework solution, the pH value of the solution is lowered. When the compound containing iron is added to the vanadium organic framework solution, the pH value of the solution is lowered so that some of vanadium in the vanadium metal oxide framework can be substituted with iron.

According to an embodiment of the disclosure, the compound containing iron may be selected from group consisting of iron trichloride and iron salts with three valence electrodes.

According to an embodiment of the disclosure, in the iron-vanadium organic framework solution preparation step, a heating condition may include heating at a temperature of 50 to 120° C. for 9 to 16 hours. The heating temperature may be selected from a group consisting of a temperature of 50 to 100° C., a temperature of 60 to 100° C., and a temperature of 60 to 90° C. The heating time may be selected from a group consisting of a period of 10 to 16 hours, a period of 10 to 15 hours, and a period of 10 to 14 hours.

According to an embodiment of the disclosure, in the carbon-coated iron-vanadium metal oxide framework preparation step, a heating condition may include heating at a temperature of 500 to 1000° C. for 2 to 6 hours. Under this heating condition, the iron-vanadium metal oxide framework may be carbonized to prepare the carbon-coated iron-vanadium metal oxide framework. The heating temperature may range from 500 to 900° C. or from 600 to 900° C. The heating time may range from 2 to 5 hours or from 3 to 5 hours.

Below, embodiments of the disclosure will be described in more detail. Such embodiments are for illustrative purpose only, and not intended to limit the scope of the disclosure.

### Preparation Example 1: Preparation of a Catalyst Composite (Fe/V—C) for the Zinc-Air Battery

First, to prepare a V-MOF (MIL-47) compound, 1.579 g of vanadium (III) chloride and 1.081 g of 1,4-naphthalenedicarboxylate were subjected to a hydrothermal synthesis reaction.

In this case, to prepare the V-MOF (MIL-47) compound, the heat treatment was performed at 200° C. for 48 hours.

Next, to prepare the FeV-MOF, 500 mg of V-MOF (MIL-47) and 250 mg of iron (III) chloride were mixed and subjected to the hydrothermal reaction at 80° C. for 12 hours, thereby synthesizing the MOF catalyst composite precursor (FeV-MOF).

Next, to prepare a Fe/V—C compound as the catalyst composite, the FeV-MOF was subjected to the heat treatment at 900° C. for 1 hour.

Thus, the catalyst composite (Fe/V—C) for the zinc-air battery was prepared.

### Preparation Example 2: Fabrication of a Zinc-Air Battery System Containing the Catalyst Composite for the Zinc-Air Battery

First, the Fe/V—C catalyst composite for the zinc-air battery, prepared by Preparation Example 1, was used as the positive electrode.

Next, a zinc plate material was used as the negative electrode.

Next, a mixed aqueous solution material of 6 M KOH+0.2 M zinc acetate was used as the electrolyte solution, and the Fe/V—C catalyst composite positive electrode for the zinc-air battery and the zinc plate negative electrode were assembled with the electrolyte solution of the mixed aqueous solution of 6 M KOH+0.2 M zinc acetate, thereby fabricating the zinc-air battery system.

### Preparation Example 3: How to Prepare the Carbon-Coated Iron-Vanadium Metal Oxide Framework (Hereinafter Referred to As“Fe—V—O@C Bimetallic”

The Chemicals used in synthesizing the vanadium metal oxide framework (hereinafter referred to as “V-MOF” or “MIL-47”) were vanadium (III) chloride and 1, 4-naphthalenedicarboxylate. The reaction performed for synthesizing the V-MOF (MIL-47) was carried out at 200° C. for 48 hours.

Chemicals used in synthesizing the FeV-MOF were the V-MOF (MIL-47) andiron (III) chloride.

The reaction performed for synthesizing the FeV-MOF was carried out at 80° C. for 12 hours.

The pretreatment process performed for synthesizing the Fe—V—O@C was carried out at 300° C. for 8 hours.

The reaction performed for synthesizing the Fe—V—O@C was carried out at 700° C. for 4 hours.

The atmosphere in which the Fe—V—O@C is subjected to the heat treatment includes a mixture of argon gas and hydrogen.

### Preparation Example 4: Fabrication of an Fe—V—O@C Bimetallic Multivalent-Ion Battery

The multivalent-ion battery was fabricated using an Fe—V—O@C positive electrode material for the positive electrode.

The multivalent-ion battery was fabricated using a Zn metal or carbon counter electrode.

The electrolyte for the multivalent-ion battery may use an organic solvent and an aqueous solvent.

### Experiment Example 1: Experiment for Testing the Surface Characteristics of the Metal Carbide Catalyst Composite

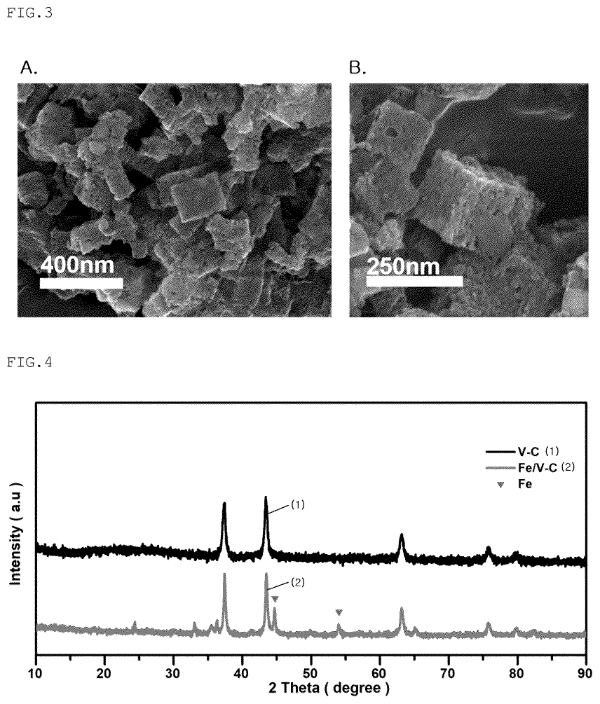

Referring to FIG. 3, the surface characteristics of the metal carbide catalyst composite will be described.

FIG. 3 is a scanning electron microscope (SEM) image of Preparation Example 1.

FIG. 3 shows the SEM image obtained by taking the metal carbide catalyst composite of Preparation Example 1 under conditions of 45,000 times ((a) in FIG. 3) or 120,000 times ((b) in FIG. 3).

(a) in FIG. 3 shows that the metal carbide catalyst composite has a regular rectangular parallelepiped structure, and (b) in FIG. 3 shows that the metal carbide catalyst composite is a porous material.

### Experiment Example 2: Experiment for Testing the Composition of the Metal Carbide Catalyst Composite

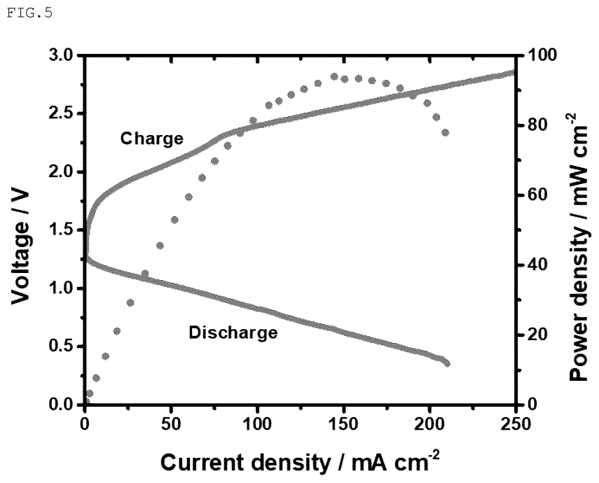

Referring to FIG. 4, the composition characteristics of the metal carbide catalyst composite will be described.

FIG. 4 shows X-ray diffraction (XRD) analysis results of Preparation Example 1.

Referring to FIG. 4, the metal carbide catalyst composite derived from the MOF showed the peaks at values of 37, 43, and 44, and it is thus appreciated that the metal carbide catalyst composite contains iron (Fe) and vanadium (V).

### Experiment Example 3: Experiment for Evaluating the Electrical Performance of the Zinc-Air Battery System Containing the Metal Carbide Catalyst Composite

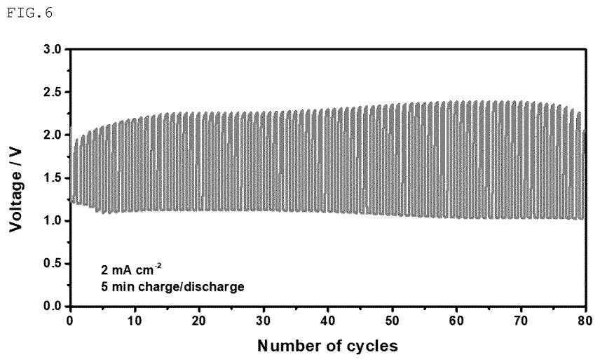

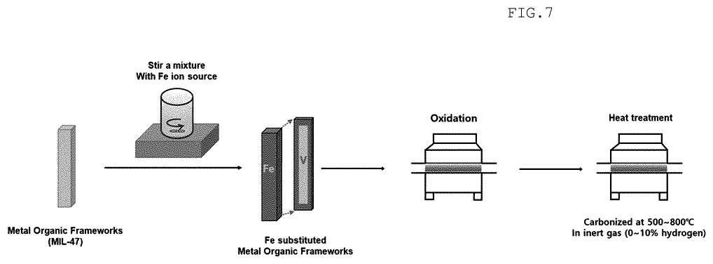

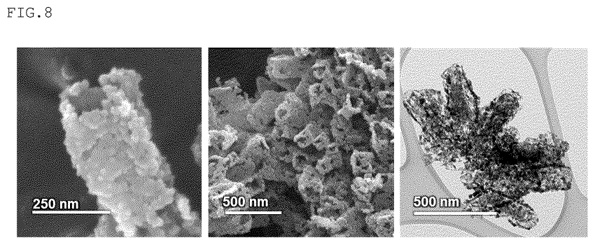

Referring to FIGS. 5 and 6, the electrical performance of the metal carbide catalyst composite is as follows.

FIG. 5 is a graph showing a charging and discharging polarization curve and a power density curve of Preparation Example 2.

FIG. 5 is a graph showing charging and discharging voltages and discharging power density depending on current density.

Referring to FIG. 5, the zinc-air battery system (Preparation Example 2) fabricated using the metal carbide catalyst composite of Preparation Example 1 as the air electrode (or positive electrode) exhibited on a power density of 94 mW/cm², a voltage of 1.77 V during charging at a current density of 10 mA cm⁻², and a voltage of 1.18 V during discharging, there exhibiting a low charging voltage and a high discharging voltage.

FIG. 6 shows stability test results of constant current charging and discharging cycle of Preparation Example 2.

Referring to FIG. 6, the zinc-air battery system (Preparation Example 2) of the disclosure provides a charging voltage of 2.30 V and a discharging voltage of 1.10 V with a voltage difference of 1.20 V therebetween.

Further, the zinc-air battery system (Preparation Example 2) of the disclosure maintains the difference between the charging and discharging voltages well while operating for more than 80 cycles, charging/discharging performance and excellent stability.

### Experiment Example 4: Analysis of Structural Characteristics of Fe—V—O@C Bimetallic

SEM and TEM images were taken through SEM and TEM apparatuses.

Crystal structure was analyzed with XRD.

Below, the accompanying drawings based on the embodiments of the disclosure or Experiment Examples will be described.

FIG. 8 shows SEM and TEM images of a tube-shaped material for a secondary battery positive electrode active material according to an embodiment of the disclosure. Referring to FIG. 8, the electrolyte diffusion performance was increased due to the increased specific surface area and pores of the carbon-coated iron-vanadium metal oxide framework.

### Experiment Example 5. Evaluation of Electrochemical Performance of the Fe—V—O@C Bimetallic Multivalent-Ion Battery

The electrochemical performance was measured in a two-electrode system.

For the electrochemical performance, the magnesium ion battery and the zinc ion battery were used.

For the electrochemical performance, the capacity of the secondary battery was tested by a galvanostatic charge-discharge method.

For the electrochemical performance, zn metal in the zinc ion battery was used as the counter electrode.

For the electrochemical performance, the electrolyte in the zinc ion battery was zinc trifluoromethanesulfonate having a concentration of 3 M.

For the electrochemical performance, the magnesium ion battery was used, and a carbon electrode was used as the counter electrode.

For the electrochemical performance, the electrolyte in the magnesium ion battery was magnesium (II) Bis (trifluoromethanesulfonyl) imide having a concentration of 0.3 M.

Below, the accompanying drawings based on the embodiments of the disclosure or Experiment Examples will be described.

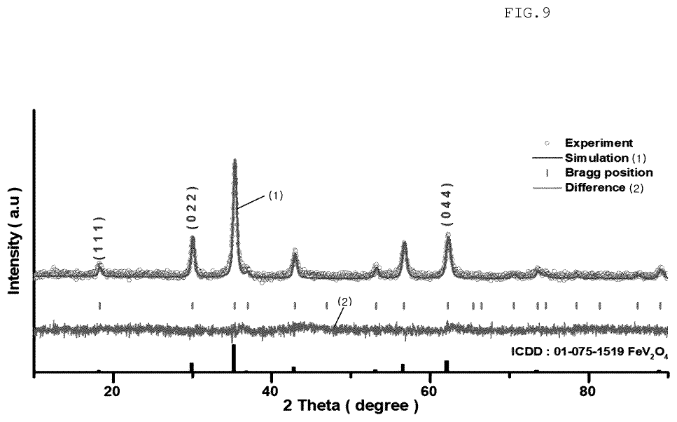

FIG. 9 is a diagram showing the structure of an iron-vanadium metal oxide framework according to an embodiment of the disclosure. Referring to FIG. 9, the structure is a tube-shaped carbon metal oxide structure.

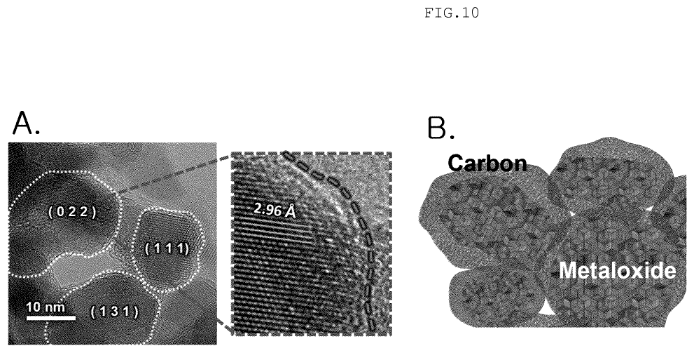

FIG. 10 is a diagram showing a nanocrystal of the carbon-coated iron-vanadium metal oxide framework according to an embodiment of the disclosure. Referring to FIG. 10, one to three carbon coating layers were coated surrounding metal oxide.

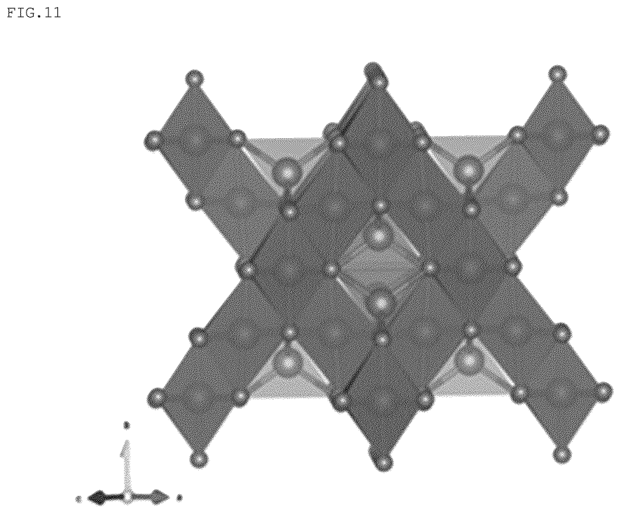

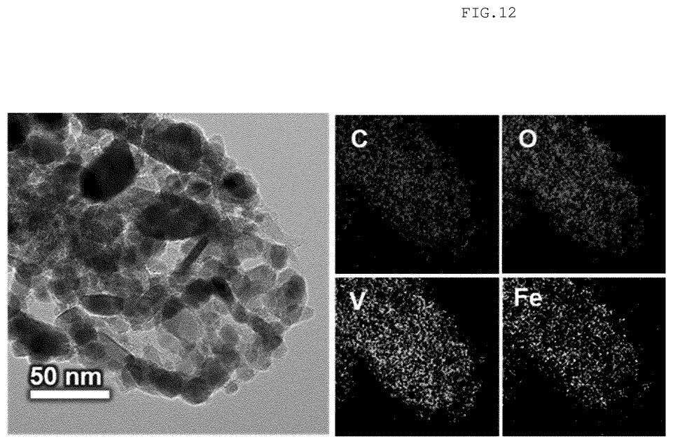

FIG. 11 is a diagram showing crystal structures of an iron-vanadium metal oxide framework (FeV₂O₄) and carbon-coated iron-vanadium metal oxide framework according to an embodiment of the disclosure. Specifically, FIG. 11 shows the spinel structure of FeV₂O₄. Referring to FIG. 11, the oxide forms of vanadium and iron are shown.

FIG. 12 is a diagram showing the composition of iron-vanadium metal oxide according to an embodiment of the disclosure. Referring to FIG. 12, vanadium and iron oxide are uniformly mixed.

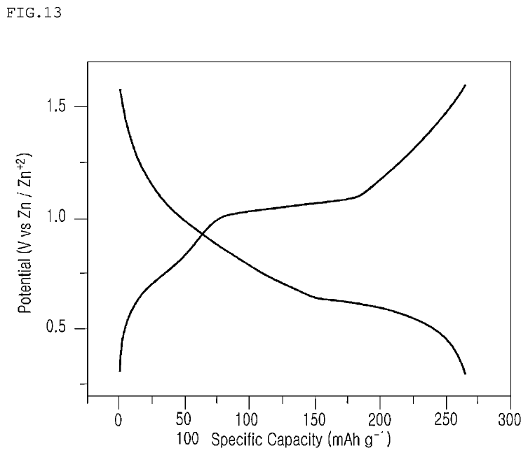

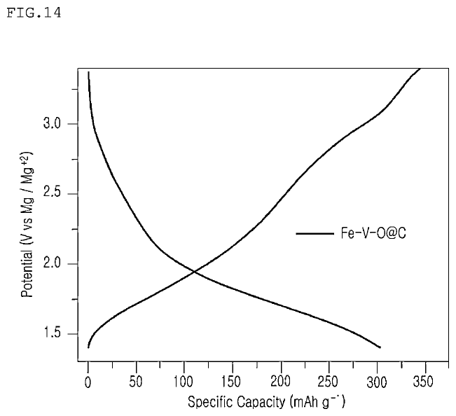

FIG. 13 shows results of applying a material for a secondary battery positive electrode active material according to an embodiment of the disclosure as a positive electrode material to a zinc ion battery. Referring to FIG. 13, the zinc ion secondary battery has a capacity of 265 mA/g.

FIG. 14 shows results of applying a material for a secondary battery positive electrode active material an embodiment of the disclosure as a positive electrode material to a magnesium ion battery. Referring to FIG. 14, the magnesium ion secondary battery has a capacity of 305 mAh/g.

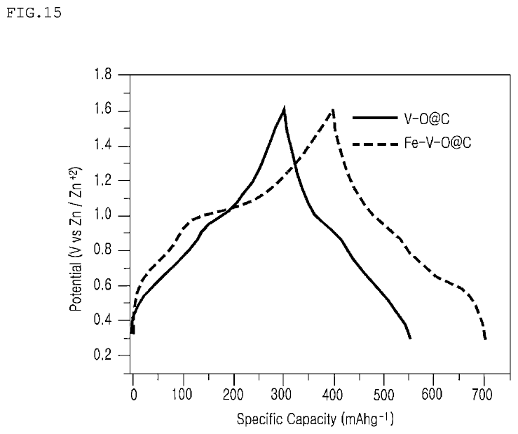

FIG. 15 shows difference in performance between vanadium oxide and iron-vanadium oxide according to an embodiment of the disclosure. Referring to FIG. 15, the capacity of iron-vanadium oxide is larger than that of vanadium oxide by 150 mA/g or more.

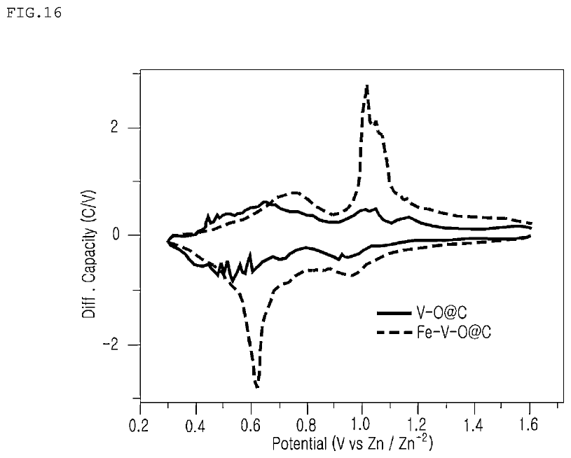

FIG. 16 shows the charging and discharging voltages of vanadium oxide and iron-vanadium oxide according to an embodiment of the disclosure. Referring to FIG. 16, the charging and discharging voltages of iron-vanadium oxide are higher than those of vanadium oxide.

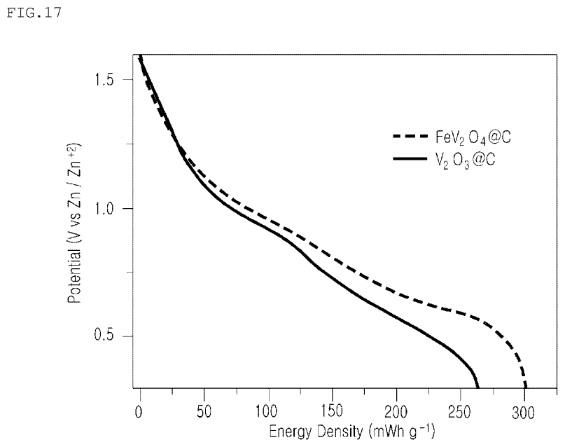

FIG. 17 shows difference in discharging energy density between vanadium oxide and iron-vanadium oxide according to an embodiment of the disclosure. Referring to FIG. 17, the charging and discharging energy density of iron-vanadium oxide is higher than that of vanadium oxide.

According to an embodiment of the disclosure, the metal carbide catalyst composite for the zinc-air battery has effects on exhibiting high activity for not only the OER performance but also the ORR performance due to its high specific surface area.

Further, according to an embodiment of the disclosure, a catalyst reaction area may be increased by the substituted iron and vanadium ions of the metal carbide catalyst composite for the zinc-air battery, thereby having effects on exhibiting high activity for the ORR performance as well as the OER performance.

Further, according to an embodiment of the disclosure, the zinc-air battery system containing the t metal carbide catalyst composite for the bifunctional zinc-air battery is excellent in electrical conductivity, and exhibits excellent charging and discharging performance and stability due to its high specific surface area.

Further, according to an embodiment of the disclosure, due to strong crystallinity of iron-vanadium-oxygen (Fe—V—O) in the material for the secondary battery positive electrode active material, spaces for insertion and extraction of specific multivalent ions are provided, energy storage performance are improved, the specific surface area and pores are increased, and electrolyte diffusion performance is enhanced.

The effects of the disclosure are not limited to the forementioned effects, but should be understood to include all other effects inferable from the configuration of the disclosure described in the detailed description or claims

The foregoing descriptions of the disclosure are for illustrative purposes only, and it will be appreciated by a person having ordinary knowledge in the art, to which the disclosure pertains, that change to other specific forms can be made easily without departing from the technical spirit or essential features of the disclosure. Therefore, the foregoing embodiments should be understood as illustrative and not restrictive in all aspects. For example, each component described in a united form may be implemented as divided, and similarly, the components described in a divisional form may also implemented as united.

The scope of the disclosure is defined by the appended claims, and all changes or modifications in the meaning and the scope of the appended claims and their equivalents should be construed as falling within the scope of the disclosure.

### DESCRIPTION OF REFERENCE NUMERALS

10: metal organic framework with vanadium metal (V-MOF)
20: MOF catalyst composite precursor
30: metal carbide catalyst composite

What is claimed is:

1. A metal carbide catalyst composite for a zinc-air battery comprising a porous carbide compound that contains vanadium metal and heterogeneous transition metal.

2. The metal carbide catalyst composite of claim 1, wherein the heterogeneous transition metal contains one selected from a group consisting of Fe, Ni or Co.

3. The metal carbide catalyst composite of claim 1, wherein content of the vanadium metal ranges from 50 wt % to 83 wt %.

4. The metal carbide catalyst composite of claim 1, wherein content of the heterogeneous transition metal ranges from 10 wt % to 20 wt %.

5. A method of producing a metal carbide catalyst composite for a zinc-air battery, comprising:
preparing a metal organic framework that contains vanadium metal (V-MOF);
forming a MOF catalyst composite precursor by substituting some of vanadium metal of the V-MOF with heterogeneous transition metal; and
preparing the metal carbide catalyst composite that contains both vanadium metal and heterogeneous transition metal by subjecting the MOF catalyst composite precursor to heat treatment.

6. The method of claim 5, wherein in the preparation of the V-MOF, the metal organic framework (MOF) comprises one selected from a metal organic composite group consisting of MIL-47 series, the vanadium metal, and organic ligands.

7. The method of claim 5, wherein in the preparation of the metal carbide catalyst composite, the heat treatment is performed within a temperature range from 800° C. to 1000° C.

8. A zinc-air battery system comprising:
a positive electrode that contains the metal carbide catalyst composite for the zinc-air battery of claim 1 to react with oxygen in air;
a negative electrode disposed to face the positive electrode and containing zinc; and
an electrolyte solution.

9. The zinc-air battery system of claim 8, wherein the electrolyte solution comprises an acidic aqueous solution or an alkaline aqueous solution.

10. A material for a positive electrode active material of a secondary battery comprises a carbon-coated iron-vanadium metal oxide framework.

11. The material of claim 10, wherein the secondary battery comprises a zinc ion secondary battery or a magnesium ion secondary battery.

12. The material of claim 10, wherein the iron-vanadium metal oxide framework is represented by Chemical Formula 1 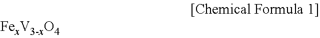
(where, x is 1 to 2).

13. The material of claim 10, wherein the iron-vanadium metal oxide framework has a spinel structure.

14. The material of claim 10, wherein the iron-vanadium metal oxide has a tubular morphology.

15. The material of claim 10, wherein the iron-vanadium metal oxide hierarchically coated with a turbostratic carbon layers has a porous nanotubular structure, where the smaller nanocrystalline iron-vanadium metal oxide spinel phase was embedded into the amorphous V—O—Fe phase.

16. The material of claim 10, wherein the iron act as a pillar to stabilize the reconstructed crystal structure through the chemical bond with oxygen when the crystal lattice is expanded upon the multivalent ion insertion.

17. A secondary battery comprising:
a secondary battery positive electrode that contains the material for a secondary battery positive electrode active material of claim 10;
a negative electrode; and
an electrolyte.

18. A method of producing a material for a secondary battery positive electrode active material, comprising:
a vanadium organic framework solution preparation step of preparing a vanadium organic framework by reacting a vanadium salt and a compound containing two or more carboxyl groups in a solvent;
an iron-vanadium organic framework solution preparation step of preparing an iron-vanadium organic framework solution to prepare an iron-vanadium organic framework by substituting some of vanadium in the vanadium organic framework with iron in such a way that a compound containing iron is added to the vanadium organic framework solution and heated; and
a carbon-coated iron-vanadium metal oxide framework preparation step of preparing a carbon-coated iron-vanadium metal oxide framework by heating the iron-vanadium organic framework solution.

19. The method of claim 18, wherein the compound containing two or more carboxyl groups is selected from a group consisting of naphthalene dicarboxylate and benzenedicarboxylate.

20. The method of claim 18, wherein in the iron-vanadium organic framework solution preparation step, a heating condition comprises heating at a temperature of 50 to 120° C. for 9 to 16 hours.

21. The method of claim 18, wherein in the carbon-coated iron-vanadium metal oxide framework preparation step, a heating condition comprises heating at a temperature of 500 to 1000° C. for 2 to 6 hours.
